(19) United States
(12) Patent Application Publication
(10) Pub. No.: US 2015/0074031 A1
(43) Pub. Date: Mar. 12, 2015

(54) Computer implementation of term functor logic, (TFL), based on directed graph representation of TFL

(71) Applicant: Dabvid M. Massie, Califon, NJ (US)

(72) Inventor: Dabvid M. Massie, Califon, NJ (US)

(21) Appl. No.: 13/987,835

(22) Filed: Sep. 7, 2013

(51) Int. Cl. G06N 7/00; G06F 17/16

(52) U.S. Cl. CPC G06N 7/00; G06F 17/16
USPC 706/46

(57) ABSTRACT

The invention is a method of computer implementation of Term Functor Logic (TFL), embodied in a fully functional prototype, a computer program, Functor Logic Processor-Version 1, (FLP-1). The method is the “FLP method”, FLP. Input to FLP-1 consists of sentences (logical formulae) in TFL. Output are sentences that are the logical conclusions, (deductive inferences) derivable from the Input. FLP provides a “natural deduction” system for TFL, a basis for expert systems for logical analysis of input data, capable of wide application. The FLP method is based on a functional representation of the Input by a non-planar directed graph. All Output is determined from the adjacency matrix of the directed graph by algorithmic routines, including calculations of conclusions in a functor algebra unique to the method.

### CROSS REFERENCE TO RELATED APPLICATIONS

Provisional patent application No. 61/743,757, Filing date Sep. 11, 2012. The title of the invention is the same as that of the present application, and the content of the Summary, Detailed description, Claim, and Abstract is identical to that of the present application; they differ only in minor editorial changes (e.g., spelling and grammatical corrections).

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The general field of endeavor to which this application pertains is the computer implementation of formal logic, i.e., the design and programming of computer programs to derive conclusions from premises within a given system of formal (mathematical) logic. The claimed invention is a method of such implementation for Term Functor Logic, (TFL), a highly algebraic form of Predicate Functor Logic, (PFL). Principal references (published papers or books) related to the development of TFL, PFL, or both, are:
Quine, W. V. O., (1982) “Methods of Logic”, Harvard University Press.
Sommers, Fred et al, (1982) “The Logic of Natural Language”, Oxford University Press.
Massie, D. M., (1971) “A Philosophical Essay on the Logic of Terms”, doctoral dissertation, Columbia University.
Bacon, John, (1985) “The Completeness of a Predicate Functor Logic”,

The Journal of Symbolic Logic, 1985.

There are no published (or unpublished) accounts of a method of implementation for TFL or PFL known to this inventor that are at all related to the method described in this application. (See Claims, below, p. 18). There have been prior methods of implementation of TFL, notably those of Pei Wang (“Toward a Unified Artificial Intelligence, published by AAAI in 2004), and Jacob Schwartz et al, of the Computer Science Dep't., New York University.) Both are intended for academic research and not as platform for the development of expert systems of general application, and neither is computationally efficient (of polynomial complexity of low order). Nor does any system known to this inventor make use of either a graph theoretic representation, or of an intrinsic functor algebra.

The specific problems in the prior state of logic computer implementation technology toward a solution of which the present invention is directed are:
1) Efficiency of computation, i.e., a low level of computational complexity;
2) Ease of algorithmic intertranslation, with both natural language (NL) and standard order logic predicate (FO), with TFL;
3) User interaction with and control of TFL based program.

The FLP implementation method for which a patent is sought in this application provides remarkably direct and efficient solutions to all of these problems.

### SUMMARY OF THE INVENTION

The invention is a method of computer implementation of Term Functor Logic (TFL). TFL is a 1st-order Predicate Functor Logic, deductively equivalent to 1st order Predicate Logic. The implementation method, FLP, (Functor Logic Processor), is based on a functional representation of sentences in TFL, the Input, by a non-planar directed graph. The Output of FLP, logical deductions from the Input, also sentences in TFL, is determined from the adjacency matrix of the directed graph by algorithmic routines, including calculations of conclusions in a functor algebra unique to the method. The method is efficient; computational complexity is polynomial of order <3 . FLP provides a “natural deduction” system for TFL, a basis for expert systems for logical analysis of input data, capable of a wide variety of applications. FLP is embodied in a fully functional prototype, a computer program, Functor Logic Processor-Version 1, (FLP-1).

### BRIEF DESCRIPTION OF THE SEVERAL VIEWS OF THE DRAWING

Not Applicable.

### DETAILED DESCRIPTION OF THE INVENTION

The invention is a method of computer implementation of Term Functor Logic (TFL), that is embodied in a fully functional prototype, a computer program, Functor Logic Processor -Version 1, (FLP-1), which is a basis for expert systems (“rule-based systems” or “knowledge-based systems”). We shall refer to the invention as the “FLP method”, or FLP. FLP is built on the formation rules (syntax), logical axioms, and rules of inference of TFL, that provide a formal framework for deductive inference, in effect a natural deduction system, just as the rules (or axioms) of a geometry, or any formal system, provide the basis for inferences (conclusions) within that system Input to the system consists of sentences (in TFL), defining rules and governing interpretation for a specific application, (the “application rules”), together with statements providing the specific data describing “events”, “state descriptions”, of the events to be analyzed. For instance: for an application to interpret pharmaceutical preclinical trial results, the input would consist of the rules of analysis and interpretation of any given event in a specific trial (the “application rules”); so each such trial would have a set of rules for interpretation of any result, as well as rules for broader interpretation, if necessary; the specific event inputs would be specific trial results, (e.g., weight results per animal per week). The output, logical inferences (or predictions, (if the system is predictive) would be logical inferences, i.e., interpretations of specific trial results, determined by the rules of the system (axioms) and the input for specific events. For each application, rules and definitions that characterize that application and its rules of interpretation, and the specific data to be analyzed, are all input to the system—not programmed; hence both rules and data can be changed online without reprogramming, and the system is available for immediate application to a great variety of applications.

Term Functor Logic (TFL), is a version of Predicate Functor Logic (PFL), deductively equivalent to standard 1st Order Predicate Logic (FO). In TFL, “terms”, representing classes (intentionally defined sets), replace the predicates of FO. Hence, individual variables, quantifiers over individual variables, and principal intra-sentential Boolean operators are eliminated, replaced by functors that act on terms and combine quantifiers and principal connectives. For instance:
FO: (x)(A(x)⊃B(x)) (“For every x, if x is A then x is B”)
TFL: ∀AS (“All A is B”) or, explicitly, “Every member of the class A is a member of the class B”. In the FLP implementation of TFL, the range of functors, hence of quantification, is limited to non-compound sentences, however complex; it therefore implements a guarded fragment of TFL. (The FLP method, however, applies to the complete TFL.)

The fundamental logical (syntactic) form of elementary sentences (wffs) in TFL is qSP, where q is a functor and S and P are terms; if S and P are “elementary” terms, then qSP is “atomic”. Note that this is a binary logical form: that is, two terms, a “subject term”, S, and a “predicate term”, P, are necessary constituents of any sentence in TFL. (In relational sentences, subject terms are multiple, and the predicate term is a relational term.)). The version of TFL used in FLP is unique; there is no standard language for TFL as yet, and the notation used in FLP was defined for the system to maximize both simplicity and ease of algebraic calculation.

TFL is a rich expressive language, closer to natural language (NL) than any other formal logic to date. This is a result of its S-P logical form and the variety and complexity of term forms permitted by the syntax. Since TFL is deductively equivalent to FO, if a statement (wff) is provable in FO, the TFL equivalent statement is provable in TFL and any proof in FO corresponds to a proof in TFL. In addition, the relatively simple logical form (syntax) of TFL offers great advantages over FO for computer implementation, and for simplicity of translation from/to natural language.

Terms:
Elementary: Ai, Bi, Ci, etc., where i=1,2,3, . . .
Boolean: <Ai β Bj>, where β is either ∩ or ∪ or ⊃, and A and B are any terms.
Relational: where R is a relation of degree n. I.e., R^{1,2} is a binary relation.
Negation: If X is a term, then −X is a term, the negation of X. Terms by these definitions may be elementary, compound (containing Boolean compounds), relational, or complex (containing combinations of two or more of these forms).

Functors. A functor of TFL quantifies and orders the logical relation between terms S and P in the sentence it governs, as in ∀SP (“All S is P”). As a “functor”, it operates on terms to form sentences of a specific logical structure, and at another level, relates the classes described by the terms. Elementary functors:
∀, the universal functor, as in ∀SP, “All S is P”, where S or P can be elementary, Boolean, or truncated relational terms ([0005]).
∃, the existential functor, as in ∃SP, “Some S is P”, where S or P can be either elementary, Boolean, or truncated relational terms. ∃SP is equivalent in FO to ∃(x)(S(x)∩P(x)), “There is at least one x such that it is both S and P”.
*, the instantiation functor, as in *SP , “Exactly one S is P” where S is a proper name or designated individual instance of S, as in “Caesar is a Roman”: *CR.

Each elementary functor, q, has 3 contextual variants: qᵢ, qᵢ⁺, and qᵢ⁻:
qᵢ operates on the ith related term in a relational sentence where Ri 1,2, . . . n is a relation of degree n.
qᵢ⁺ is a relational functor with positive “distribution value” in a truncated relation.
qᵢ⁻is a relational functor with negative “ distribution value” in a truncated relation.

Note: The term “distribution value” is an anachronism, and the notion of “positive” or “negative” values a useful convention, indicating the antecedent (“negative”) or consequent (“positive”) in the inclusion relation indicated by the universal functor, ∀.

Not all of these variants are functionally distinct for each functor; e.g., ∀ᵢ^{-=∀}ᵢ. The result is that there are 8 functionally distinct functors, and a null functor, Ø, in the set of distinct functors in the FLP method. e.g., ∀ᵢ⁻=∀ᵢ. The result is that there are 8 functionally distinct functors, and a null functor, Ø, in the set of distinct functors in the FLP method.

Relational Sentences. A relational sentence in TFL has the general form q1Xᵢq2Xᵢ . . . qnXᵢR^{1,2, . . . n}, where R^{1,2, . . . n} is a relational term of degree n, the qi are elementary functors operating on the ith subject term in the relation, and the Xi are terms, either elementary or Boolean, not necessarily different. For instance, ∀1A(∃2B∀3CR^{1,2,3}) is a ternary relational sentence, in which R^{1,2,3} is a ternary relational term, A, B, and C are the related terms, and ∀1A, ∃2B, and ∀3C are the functor - governed subject terms, forming partial relational sentences with the relation, R^{1,2,3.}. So, in ∀1A . . . R^{1,2,3}, ∀1A is a relational subject, and R^{1,2,3} is the relational predicate of a “partial relational sentence”. (The parens in the initial sentence are a notational convenience for further processing by the Parser).

For example, the TFL representation of “Every mother is the parent of some child” would be ∀1M(∃2CP^{1,2}). Any relational sentence can be written as a subject-predicate sentence, of (S-P) form. E.g., ∀1M(∃2CP^{1,2}) can be written as ∀M(∃2CP^{1,2}), where (∃2CP^{1,2}), the predicate term, is a “truncated relational term”.

Relational Sentences. A relational sentence in TFL has the general form q1Xᵢq2Xᵢ . . . qnXᵢR^{1,2, . . . n}, where R^{1,2, . . . n} is a relational term of degree n, the qi are elementary functors operating on the ith subject term in the relation, and the Xi are terms, either elementary or Boolean, not necessarily different. For instance, ∀1A(∃2B∀3CR^{1,2,3}) is a ternary relational sentence, in which R^{1,2,3} is a ternary relational term, A, B, and C are the related terms, and ∀1A, ∃2B, and ∀3C are the functor-governed subject terms, forming partial relational sentences with the relation, R^{1,2,3.}. So, in ∀1A . . . R^{1,2,3} , ∀1A is a relational subject, and R^{1,2,3} is the relational predicate of a “partial relational sentence”. (The parens in the initial sentence are a notational convenience for further processing by the Parser).

For example, the TFL representation of “Every mother is the parent of some child” would be ∀1M(∃2CP^{1,2}). Any relational sentence can be written as a subject-predicate sentence, of (S-P) form. E.g., ∀1M(∃2CP^{1,2}) can be written as ∀M(∃2CP^{1,2}), where (∃2CP^{1,2}), the predicate term, is a “truncated relational term”.

Sentence Negation. If S is a sentence, then -S is a sentence. Sentence negation is distributed over the elements and operators of a sentence -S by the Parser. The distribution rules are the same as those of FO.

FLP. FLP has four basic routines, in order: Input, Parser (including Mapping Algorithm), Derivation of Inference, and Output. These routines are all integral to and derived from the fundamental directed graph representation of TFL for which we seek a patent, and each routine will be described in detail accordingly.

Input Input to FLP, Δ, consists of sentence-candidates in TFL notation; “candidates” because expressions with syntactic errors are excluded by the Parser, and the user is notified of the explicit error(s) found . The number of input sentences, and the resulting number of distinct terms, are arbitrary; the complexity of processing is a linear function of the number of input terms except for the search routine, which is of polynomial complexity of at most degree 3. While all basic routines of FLP are integral to the program, all are designed for the adjacency matrix representation of input generated by the Parser; the adjacency matrix representation is the basis of the FLP method.

Parser. The Parser is the most complex part of the FLP method. The Parser does a complete syntactic and logical analysis of each sentence candidate in the Input, Δ: any syntactic error in such a candidate causes rejection of the candidate, and output to the user specifies the error(s) detected. The Parser also generates, and parses, logical equivalents of input sentences and parses them as well.

The output of the Parser, (which is also provided directly to the user), includes all (syntactically correct) sentences, all terms, simple, compound, and complex, and representations of the syntactic and logical structure of each sentence and each compound and complex term in ΔA. The Parser also generates, and parses, logical equivalents of input sentences, and constituent Boolean terms. The output of the Parser is mapped algorithmically into the adjacency matrix of a non-planar directed graph; the adjacency matrix is the basis both for the search for possible conclusions, for calculation of valid conclusions, proof of each conclusion, and other vital information implicit in the input to the program. The sentence representations generated by the Parser are ordered n-tuples. The representation of a sentence in TFL, qXY, is (X, ±,Y, ±, q, β, ±, ±), where, in order:
X is subject term, ± is sign, positive or negative, of X,
Y is predicate term, ± is sign of Y,
q is the principal functor of the sentence,
β is the Boolean operator, between terms in Boolean terms, (if any),
± is the inclusion sign for X,
± is the inclusion sign for Y.

Sentences can be added to the input set at any time, parsed, and mapped into the matrix, as to any adjacency matrix. In FLP, each intermediate inference in a derivation, and its logical equivalents, are parsed and mapped as they are determined. Such additions are a necessary part of any realistic mathematical derivation process. This renders the path search procedure complex, and the derivation procedure dynamic, as described below. [0011]

The Directed Graph and Adjacency Matrix. Let Γ be the set of sentences output by the Parser, G(Γ) the directed graph generated by the Parser, and |G (Γ)| the adjacency matrix for G. The vertices of G represent terms, and the edges connecting terms represent the syntactic and logical relations between terms in the sentences of Γ, generated by functors. For instance, in the sentence ∀SP, the terms S and P would be represented as vertices, and their relation, generated by the functor ∀, as subject and predicate terms respectively in the sentence, would be represented by an edge connecting the vertices.

|G(Γ)| is symmetric; each row and column represents a term in Γ, (a vertex in G(Γ)), and all terms, simple, compound, or complex, are represented; the matrix elements are the connecting operators—functors or Boolean operators—or 0, (rather than the usual 1 or 0), between each pair of terms.

In the sentence ∀<A∩B>C, (“All A and B are C”), the relation between the terms <A∩B> and A (or B) generated by the Boolean operator ∩, would be an element, ∩, in the adjacency matrix, |G(Γ)|; ∩ is the connecting operator. Boolean operators are not functors.

The Directed Graph and Adjacency Matrix Once the output of the parser, Γ, is mapped, inference is in response to specific queries, and FLP accepts queries of three forms:
1) Is any conclusion derivable in which the terms X and Y occur ? (X and Y are terms of arbitrary complexity.)
2) Is a specified conclusion, q(XY), derivable?
3) Is any conclusion derivable that includes given terms, X, Y, and a given relation, R?

These query forms include a wide variety of sentence structures, and FLP is accordingly an expressively rich deductive system.

The system responds to a query in two stages: first a Path Search procedure, and then a Derivation procedure. Both are innovative, and peculiar to the directed graph representation of the premise set. The representation is, in turn, dependent upon the logical form of sentences in TFL, and so, necessarily, is the fundamental rule of transitive inference in TFL, the Cancellation Rule.

Cancellation Rule. In its simplest form, the Cancellation Rule stipulates that:

qXY, ∀YZ|-qXZ

where q is any elementary functor, and X, Y, and Z are arbitrary terms, not necessarily different. Thus, Cancellation is a rule defining an inference between two sentences. Cancellation is analogous to modus ponens in FO, to clause resolution in the Resolution proof method, and to similar elimination rules in other systems (e.g., Gentzen's Cut Rule for sequences.) The relative power and generality of Cancellation derive from the binary logical form of TFL.

If we write the antecedents in the definition, above, as a string, qXY∀YZ, then we may represent the rule as a string contraction rule,

qXY∀YZ=qXZ

where the sequence Y∀Y is eliminated from the string, (or “word”, as in group theory.) More generally, alternative versions of both ∀ and ∃, may replace ∀ in Cancellation. So, if we replace ∀ in the definition above by Q, which includes V and its alternative versions, we can write the Cancellation

Rule as:

qXYQYZ|-qXZ,

The necessary conditions for cancellation are:

1) The instances of the cancelled term, Y, must be identical. That is, both must be of the same sign, positive of negative.

2) The inclusion signs of the two instances of Y must be, in left-right order, + and −. respectively.

3) The functor product, q·Q, must be a non-null functor in Φ, the functor algebra for F, the set of functors for FLP. (See [0010], below. p Since each term in Γ is explicitly mapped, and a term X and its negative, ˜X, are distinct terms, condition 1) is satisfied by the Parser.

Forms of the rule apply to terms embedded in compound and complex contexts, and encompass the entire range of corresponding functors; but the elimination of a sequence of the form Y∀Y is common to all forms.

Path Search. Any conclusion sought in FLP-1 is of the general form S(X,Y) , or S(X,Y,R), where S, not necessarily specified, is any sentence in TFL admissible to FLP, X and Y are specified terms of arbitrary complexity, and R is a relational term. ([0005]). If such a sentence is derivable from Γ, then it is necessary (but not sufficient) that the terms X and Y be connected in G(Γ); i.e., that the vertices representing X and Y, respectively, be connected by a path in G(Γ), p(X,Y), which is a sequence of adjacent vertices, each connected to the next by an edge. Each edge is labeled in the adjacency matrix, |G(Γ)|, by the principal functor, q, generating the sentence qSP. ([0004]); that is, an edge in G(Γ) represents the connection between S and P in a sentence, qSP, generated by the functor, q. The length of a path, n(p), is the number of edges in the path. To determine the possibility of an inference , S(X,Y), from Γ, it is necessary to find a path in G(Γ), if any, between X and Y. This search is conducted in the adjacency matrix, |G(Γ)| , where each edge is indicated (labeled) by its generating functor, or connecting Boolean operator. However, the required path may not exist in the initial version of G(r), since intermediate inferences that may be essential to the derivation are submitted to the Parser at each cancellation, and the resulting output added to Γ, G(Γ),and |G(Γ)|. Note: The output of the Parser, Γ, is determined only by Δ, the Input to the Parser. Thus, while the derivation procedure in general, and Path Search in particular, are incremental, they are determined by Δ. As a very simple instance of the complexity introduced by intermediate inferences generated and mapped by the Parser, let ∀<A∩B>C and ∀BA be in Γ. ∀<A∩B>C, ∀BA|-∀<B∩B>C. This inference, a cancellation, would be in response to a request for a path search in |G(Γ)|. Since <B∩B>=B, FLP infers ∀BC. But <B∩B>=B is a Boolean identity, not the result of cancellation; it is generated by the Parser. ∀BC, which, a product of Γ, is now added to Γ, and search possibilities are extended. That is, some paths available in |G(Γ)| are not necessarily available in |G(Γ)| initially, and so path search is a stochastic procedure. This problem is addressed in the following paragraph.

Derivation Procedure. If a conclusion, S(X,Z) is sought, and a path in G(Γ), p(X,Z), exists, then it is necessary to determine whether or not the sequence of sentences constituting the path yields the conclusion sought: that is, whether the sequence of sentences in the path p(XZ) constitute a proof in TFL. Of course, p(XZ) may not be the only path connecting X and Z; more than one such path may have to be investigated before the inference sought is found (or not). And no such path may exist initially, as described above [0008]. So we must consider several cases.

The simplest case: Let at least one path, p(XZ), exist in G(ΓF).

All immediate inferences and logical equivalences of sentences in the Input have been mapped to |G(Γ)| by the Parser. If p(XZ) can be written (in the simplest case) as a string of the form

qXY₁∀Y₁Y₂∀Y₂Y₃ . . . Yₙ∀YₙZ,

cancellation is the only rule of inference that applies. Cancellation ([0012]) acts by eliminating sequences of the form Y∀Y from a string of the form qXY∀YZ to yield the conclusion qXZ. Hence, if p(XZ) can be written as a string of the form

qXY₁∀Y₁Y₂∀Y₂Y₃ . . . Yₙ∀YₙZ,

it will reduce, by successive cancellations, to the conclusion sought, qXZ. However, the sequence of functors in the string may not be uniform. To compute string values in more complex cases, we use the Functor Algebra.

The Functor Algebra. Corresponding to a path, p(XZ), connecting X and Z in G(Γ), is a string of functors, say q1q2q3 . . . qn, characterizing the path. The cancellation of intermediate terms, Yi, between X and Z, necessary to determine an inference S(X,Z), is then dependent on the cancellation relation between the functors generating successive sentences. Since there are always two principal functors involved in any cancellation, we may consider their left-right succession in cancellation as an algebraic product: for instance, we may write ∀∀=∀, representing cancellation of the form ∀AB∀BC=∀AC.

Consider the product ∃∀=∃, representing the inference,

∃AB, ∀BC|-∃AC.

For example:
Some Men are Greek, (∃MG), All Greeks are Blond (∀GB), so, Some Men are Blond, (∃MB).

I.e., ∃∀=∃, because we have the required sequence ∃MG∀GB for cancellation.

However, it is not the case that all functor products have a logically acceptable product. i.e., permit cancellation. For example:
All Greeks are Men, (∀GM), Some Men are Blond, (∃MB), so, Some Greeks are Blond, (∃GB)?? I.e., ∀∃=∃??

Note that in the latter case, we have the succession ∀GM∃MB, which does not permit cancellation; we do not have the required M∀M sequence. So, the sequence of functors characterizing a path may not permit cancellation at each step. Let F be the set of eight functors defined for FLP ([0003]) , and let Ø denote a “null functor”, indicating no cancellation determined by the succession (product) of the two functors involved. So, for instance, ∀∃=Ø. If Ø is added to the eight functors in F, and qØ=Øq=Ø, for all functors in F, the resulting set of functors, F+=F∪Ø, constitutes a non-Abelian semigroup, Φ, closed under functor product (succession}, and associative. Calculation in Φ is completely specified by an 8×8 product table. While there are 9 functors in F+, we need not include Ø in the table, except as a product, since qØ=Øq=Ø for all q. Since Φis associative, if Ø occurs in any computational string of functors in Φ, the string reduces to Ø. Note: The sequence of inclusion values, (+,-), of the two instances of the term to be cancelled, respectively, is a necessary condition for cancellation ([0012]). The sequence of inclusion values is included in the specification of the pair-wise product of functors, and so is subsumed by the functor algebra Φ. (It's all in the product table.)

Derivation in Complex Cases. Cancellation is, as stated above, always between two sentences, in the simplest case, qAB, ∀BC|-qAC, where q is an elementary functor. Thus, cancellation can also be interpreted as a replacement rule:
qAB∀BC=qAC, and B in qAB is replaced by C.

Compound Terms:

In the sentence V<A∩B>C, the compound term can be canceled:

∀D<A∩B>∀<A∩B>C|-∀VDC.

Also, in ∀<A∩B>C, A can be cancelled in <A∩B>; or specifically, A can be cancelled in V<A∩B>C: (cancellation must between sentences.) For instance,

∀<A∩B>C, ∀DA|-∀<D∩B>C.

Here, the A in <A∩B> is governed by ∀, the functor governing <A∩B>. If such a cancellation occurs in a path, p(X,Y), then unless the resulting Boolean compound term itself is cancelled, the derivation, if any, in answer to a specific query, will contain the Boolean compound (or some substitution instance of it.) Relational Sentences: A relational sentence in TFL has the general form

q1Xᵢq2Xᵢ . . . qnXᵢR^{1,2, . . . ,n},

where R^{1,2, . . . n} is a relational term of degree n, the qi are elementary functors operating on the ith subject term in the relation, and the Xi are terms, either elementary or Boolean, not necessarily different. [0002} The relational term, R^{1,2, . . . n,}, can be cancelled, as any other predicate term. The related terms, Xi, can also be cancelled, but only within the sentence context:

∀1A(∃2B∀3CR^{1,2,3}), ∀BD|-∀1A(∃2D∀3CR^{1,2,3}) ,

where D has replaced B in the relational sentence. As a result of these cancellation restrictions, the FLP method uses three successive search procedures, if required: An S-P search, a Boolean search, and a relational search, in order, and if necessary, repetitively. Again, however many syntactic and logical transformations are performed by the Parser, the resulting inferences and paths are all determined by Δ, the initial input.

Output. Output of FLP is of two sorts: output of the Parser, and output of the Derivation procedure. Output of the Parser, (which is also provided directly to the user), includes all (syntactically correct) sentences, all terms, simple, compound, and complex, and representations of the syntactic and logical structure of each sentence and each compound and complex term. The Parser also generates, and parses, logical equivalents of input sentences, and constituent Boolean terms, and of each intermediate inference generated during the Derivation procedure.

Output of the Derivation procedure includes all sentences, if any, derived in response to specific queries. And in each case, if no conclusion of the form requested is derivable, the user is so informed. In the most general case of query, no syntactic form of conclusion is specified. The output also includes, on request, a proof of the conclusion derived, in the form of the sequence of sentences corresponding to the derivation path(s): this sequence constitutes a valid inference in TFL. FLP is sound with respect to TFL: a sentence is derivable in FLP from F only if it is derivable in TFL, which is complete.

### CLAIM

The Directed Graph Representation of Term Functor Logic (TFL) is the basis of the entire method of computer implementation of TFL described in the Specification above, for which a patent is sought. The method is embodied in in a fully functioning prototype program, FLP-1 (Functor Logic Processor—Version 1), and we refer to the method as the FLP method. The FLP method consists of a sequence of elements, basic routines, all essential to the method, and all designed for the adjacency matrix representation of the directed graph [0010], the core of the method, and therefore critical to the claim of uniqueness for the method. We describe these elements in order of function (as cited in the Specification) with respect to the adjacency matrix representation.

The Parser [0009] does a complete syntactic and logical analysis of all input sentences [0008] its principal output determines the representation of each sentence in the adjacency matrix of a symmetric, non-planar directed graph. (The graph itself, determined by the input, is virtual; the matrix is its functional representation.)

The Adjacency Matrix [0010] is the basis for the derivation of logical inferences from input , the purpose of the system [0001]. Derivation of Inference [0011] is composed of two algorithmic processes, in order: Path Search, and the Derivation Procedure.

Path Search [0013] is a search in the adjacency matrix for a connection (in the directed graph, a path) between the two vertices representing the terms , and their connecting edge, representing the principal functor, [0004], in the conclusion sought. The existence of such a path is a necessary condition for deriving an inference: thus, inference is a direct function of the adjacency matrix.

Derivation Procedure [0014]. If a path exists in the adjacency matrix between the two terms in the conclusion sought, the path will consist of a sequence of vertices (terms), connected pair-wise by a sequence of edges, each labeled by a principal functor. The string of functors constitutes a a “word”, or extended product, in the Functor Algebra [0015] which is unique to the adjacency matrix representation. The path determining a connection between the two terms, say S and P, in the conclusion sought, q(S,P), where q is the principal functor, [0004], will yield a conclusion if and only if the corresponding s string of functors reduces to a single functor under calculation in the Functor Algebra. Output [0017] of the Derivation Procedure consists not only of the conclusion(s) sought, if any, but also of a valid proof in TFL of each conclusion, which is the sequence of sentence-representations constituting the necessary path in the adjacency matrix that yield a conclusion as calculated by the Functor Algebra.

Uniqueness of the Invention. The entire sequence of elements in the FLP method is determined by the adjacency matrix of the Directed Graph Representation of input generated by the Parser. Several extensive searches

1. The Directed Graph Representation of Term Functor Logic (TFL) is the basis of the entire method of computer implementation of TFL described in the Specification above, for which a patent is sought. The method is embodied in a fully functioning prototype program, FLP-1 (Functor Logic Processor—Version 1), and we refer to the method as the FLP method. The FLP method consists of a sequence of elements, basic routines, all essential to the method, and all designed for the adjacency matrix representation of the directed graph [0010], the core of the method, and therefore critical to the claim of uniqueness for the method. We describe these elements in order of function (as cited in the Specification) with respect to the adjacency matrix representation.
The Parser [0009] does a complete syntactic and logical analysis of all input sentences [0008] its principal output determines the representation of each sentence in the adjacency matrix of a symmetric, non-planar directed graph. (The graph itself, determined by the input, is virtual; the matrix is its functional representation.)
The Adjacency Matrix [0010] is the basis for the derivation of logical inferences from input , the purpose of the system [0001]. Derivation of Inference [0011] is composed of two algorithmic processes, in order: Path Search, and the Derivation Procedure.
Path Search [0013] is a search in the adjacency matrix for a connection (in the directed graph, a path) between the two vertices representing the terms , and their connecting edge, representing the principal functor, [0004], in the conclusion sought. The existence of such a path is a necessary condition for deriving an inference: thus, inference is a direct function of the adjacency matrix.
Derivation Procedure [0014]. If a path exists in the adjacency matrix between the two terms in the conclusion sought, the path will consist of a sequence of vertices (terms), connected pair-wise by a sequence of edges, each labeled by a principal functor. The string of functors constitutes a a “word”, or extended product, in the Functor Algebra [0015] which is unique to the adjacency matrix representation. The path determining a connection between the two terms, say S and P, in the conclusion sought, q(S,P), where q is the principal functor, [0004], will yield a conclusion if and only if the corresponding s string of functors reduces to a single functor under calculation in the Functor Algebra.
Output [0017] of the Derivation Procedure consists not only of the conclusion(s) sought, if any, but also of a valid proof in TFL of each conclusion, which is the sequence of sentence-representations constituting the necessary path in the adjacency matrix that yield a conclusion as calculated by the Functor Algebra.
Uniqueness of the Invention. The entire sequence of elements in the FLP method is determined by the adjacency matrix of the Directed Graph Representation of input generated by the Parser. Several extensive searches of current and recent literature,—technical publications, journals, research reports, etc.—at the library of The Courant Institute of Mathematical Sciences (which includes the computer science collection), have revealed no evidence of either precedents for, or contemporary research on, any method of computer implementation of TFL that uses the directed graph adjacency matrix method used in the FLP method, nor indeed, any similar method. Similarly, internet search also yields negative results. In addition, the inventor (myself) wrote the first doctoral dissertation on TFL (Ph.D., 1971, Columbia University), and is familiar with the work of many of the leading investigators in the field. While there are a few academic projects using forms of implementation of TFL, none of them described in the literature uses the adjacency matrix approach, and of none of them has produced a widely applicable system, like the FLP-1 prototype.
I conclude then that the FLP method is unprecedented, unique, and appropriate for a single patent.
